(19) United States
(12) Patent Application Publication
(10) Pub. No.: US 2009/0066855 A1
(43) Pub. Date: Mar. 12, 2009

(54) TELEVISION BROADCAST RECEIVING SYSTEM

(76) Inventor: Kenichi KUMANO, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/110,700

(22) Filed: Apr. 28, 2008

(30) Foreign Application Priority Data
Sep. 10, 2007 (JP) 2007-233859

(51) Int. Cl. H04N 5/44; H04N 5/445

(52) U.S. Cl. 348/734; 725/40; 725/131; 725/58; 348/E05.096

(57) ABSTRACT

A television broadcast receiving system has a receiving apparatus receiving a broadcast of a television station that carries out datacasting as well as broadcasting and displaying an image of a television program, and a remote control remotely controlling the receiving apparatus by using wireless communication. The receiving apparatus is provided with a remote control information producing portion producing remote control information based on predetermined information, the remote control information to be wirelessly transmitted to the remote control, and a wireless transmitting portion wirelessly transmitting the remote control information to the remote control. The remote control is provided with a wireless receiving portion wirelessly receiving the remote control information. Radio waves are used as media for wireless communication from the wireless transmitting portion to the wireless receiving portion. This enables the receiving apparatus to wirelessly transmit associated information and the like obtained from the broadcast station to the remote control with relative ease, making it easy to enhance the convenience for users.

This nonprovisional application claims priority under 35 U.S.C. § 119(a) on Patent Application No. 2007-233859 filed in Japan on Sep. 10, 2007, the entire contents of which are hereby incorporated by reference.

### BACKGROUND OF THE INVENTION

1. Field of the Invention

The present invention relates to television broadcast receiving systems provided with a receiving apparatus that receives a television broadcast and a remote control for remotely controlling the receiving apparatus.

2. Description of Related Art

Currently, television broadcasting includes not only the broadcasting of image and audio information of television programs (program information) but also datacasting, which is the broadcasting of information such as EPGs (Electronic Program Guides), channels of television programs, program names, and subtitles. It is under this background that an increasing variety and amount of information are broadcast. It should be understood that, in the present specification, information provided by datacasting is referred to as “associated information”.

Television broadcast receiving apparatuses that receive not only television programs but also associated information provided by datacasting and perform operation such as display of the associated information as well as the television programs have already been widely used. In addition, remote control devices (remote controls) for remotely controlling the television broadcast receiving apparatuses have also been widely used.

An example of these widely-used remote controls is a remote control that wirelessly communicates with the receiving apparatus by using infrared rays. In addition to this, a remote control that receives some information transmitted thereto has also been proposed. For example, JP-A-2001-309463 discloses a system in which data received with a broadcast apparatus is transmitted to a remote control, and JP-A-H8-140155 discloses a system in which television audio is transmitted to a remote control.

In a case where infrared-ray communication is adopted as a wireless transmission scheme by which information is wirelessly transmitted to a remote control, it is not easy to wirelessly transmit the information with stability due to, for example, high directivity (the property of traveling in straight lines) of the infrared rays. In particular, it may be extremely difficult to wirelessly transmit information to the remote control with stability because the user often uses the remote control by directly picking it up by hand (and this causes a change in position and orientation of the remote control). As a result, there are difficulties in wirelessly transmitting the aforementioned associated information from the television broadcast receiving apparatus to the remote control, and making the remote control notify the user of the information thus transmitted.

### SUMMARY OF THE INVENTION

In view of the conventionally experienced problems described above, an object of the present invention is to provide television broadcast receiving systems that can enhance the convenience for users by making it easy for a receiving apparatus to wirelessly transmit associated information and the like obtained from a broadcast station to a remote control.

To achieve the above object, according to one aspect of the present invention, a television broadcast receiving system is provided with: a receiving apparatus receiving a broadcast of a television station that carries out datacasting as well as broadcasting and displaying an image of a television program; and a remote control remotely controlling the receiving apparatus by using wireless communication. Here, the receiving apparatus is provided with: a remote control information producing portion producing remote control information based on predetermined information, the remote control information to be wirelessly transmitted to the remote control; and a wireless transmitting portion wirelessly transmitting the remote control information to the remote control. The remote control is provided with a wireless receiving portion wirelessly receiving the remote control information. Radio waves are used as media for wireless communication from the wireless transmitting portion to the wireless receiving portion.

With this structure, the remote control information produced in the receiving apparatus is wirelessly transmitted to the remote control by using radio waves having lower directivity (the property of traveling in straight lines) than infrared rays. This enables the receiving apparatus to wirelessly transmit associated information and the like obtained from the broadcast station to the remote control with relative ease, making it easy to enhance the convenience for users.

In the above-described structure, the remote control information producing portion may produce information indicating the contents of the datacasting as the remote control information, and the remote control may be provided with a first notifying portion performing a first notification process for notifying a user of the contents of the datacasting based on the remote control information.

With this structure, it is possible to notify the user of the contents of the datacasting by means of the remote control. This helps achieve a television broadcast receiving system that offers greater convenience.

More specifically, in the above-described structure, the first notifying portion may include a display device producing a display of the contents of the datacasting based on the remote control information, and the first notifying portion may perform the first notification process by making the display device produce the display.

In the above-described structure, the receiving apparatus may include a second notifying portion performing a second notification process for notifying the user of the contents of the datacasting, and the second notifying portion may perform the second notification process when receiving an instruction given from the remote control to the receiving apparatus via wireless communication.

With this structure, it is possible to make the receiving apparatus notify the user of the contents of the datacasting in accordance with the instruction given by using the remote control. This helps achieve a television broadcast receiving system that offers greater convenience.

More specifically, in the above-described structure, the second notifying portion may include a display device producing a display of the contents of the datacasting, and the second notifying portion may perform the second notification process by making the display device produce the display.

More specifically, in the above-described structure, as a wireless communication scheme from the wireless transmitting portion to the wireless receiving portion, any one of the IEEE802.11 wireless LAN, Zigbee, and Bluetooth may be adopted.

More specifically, in the above-described structure, as a wireless communication scheme from the remote control to the receiving apparatus, any one of the IEEE802.11 wireless LAN, Zigbee, and Bluetooth may be adopted.

More specifically, in the above-described structure, the first notifying portion may produce a predetermined sound at the time of execution of the first notification process, and the second notifying portion may produce a predetermined sound at the time of execution of the second notification process.

More specifically, in the above-described structure, the receiving apparatus may receive EPG data by the datacasting, and the first notifying portion may display the EPG data. In addition, the receiving apparatus may receive, by the datacasting, digital data indicating at least one of a broadcast channel, a program name, and subtitles of the television program, and the first notifying portion may display the digital data.

In the above-described structure, the receiving apparatus may include an automatic start managing portion in which a preset program time is previously set, the automatic start managing portion starting an image display of a television program of a predetermined channel when the preset program time has come. The remote control information producing portion may produce, as the remote control information, information indicating that the preset program time has come. Based on the remote control information, the remote control may notify the user that the preset program time has come.

With this structure, by previously setting the preset program time, it is possible to automatically start the image display of the television program at the preset program time. This makes it possible, for example, to minimize the possibility that the user inadvertently misses the television program. In addition, since the remote control notifies the user that the preset program time has come, it is possible to prevent more reliably the possibility that the user misses the television program.

In the above-described structure, the receiving apparatus and the remote control each may include a transmitter portion wirelessly transmitting audio information or image information according to an input of the user to a receiving side and a receiver portion performing an audio output or image display based on the audio information or image information wirelessly transmitted from a transmitting side. Here, the user performing the input to the receiving apparatus and the user performing the input to the remote control may be allowed to communicate with each other by perceiving the audio output or image display.

With this structure, users are allowed to communicate with each other by using the receiving apparatus and the remote control as transceivers. This helps achieve a television broadcast receiving apparatus that offers more convenience for users.

### BRIEF DESCRIPTION OF THE DRAWINGS

This and other objects and features of the present invention will become clear from the following description, taken in conjunction with the preferred embodiments with reference to the accompanying drawings in which:

FIG. 1 is an explanatory diagram showing an outline of a television broadcast receiving system according to an embodiment of the invention;

FIG. 2 is a block diagram of the receiving apparatus according to the embodiment of the invention;

FIG. 3 is a block diagram of the remote control according to the embodiment of the invention;

FIG. 4 is a flow chart showing the procedures performed in the remote control according to the embodiment of the invention; and

FIG. 5 is a flow chart showing the procedures performed in the receiving apparatus according to the embodiment of the invention.

### DETAILED DESCRIPTION OF PREFERRED EMBODIMENTS

Hereinafter, an embodiment of the present invention will be described, taking up as an example a television broadcast receiving system for receiving a television broadcast.

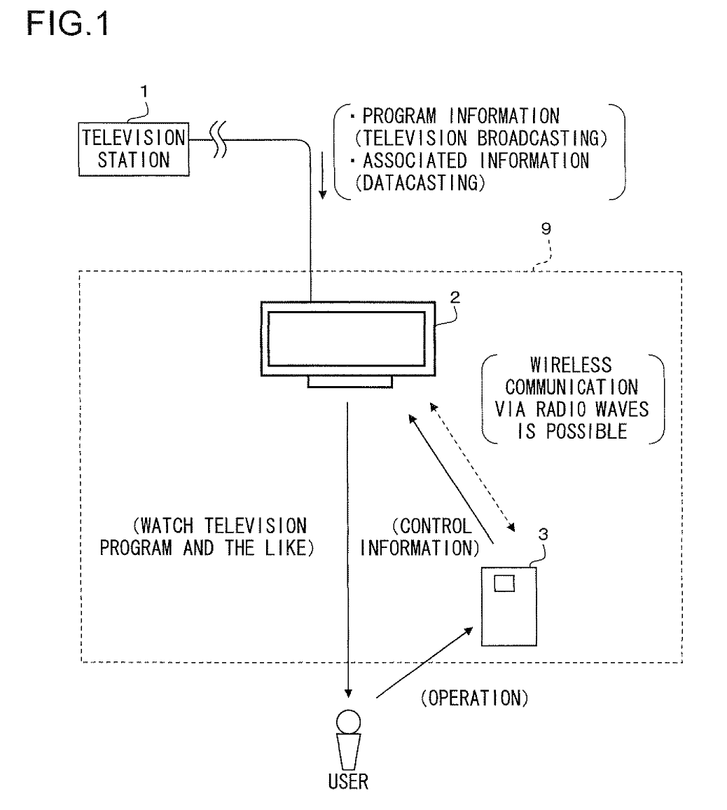

An outline of the configuration of the television broadcast receiving system is shown in FIG. 1. As shown in this figure, the television broadcast receiving system 9 includes a television broadcast receiving apparatus (hereinafter a “receiving apparatus”) 2, and a remote control device (hereinafter a “remote control”) 3. The television broadcast receiving system 9 allows the user to control the receiving apparatus 2 by operating the remote control 3, and watch a television program and the like. It is to be noted that the television station 1 and the receiving apparatus 2 may be connected to each other with or without wires. In addition, as will be described later, the receiving apparatus 2 and the remote control 3 can wirelessly communicate with each other via radio waves.

In addition to television broadcasting in which information (program information) representing images and audio of regular television programs is broadcast, the television station 1 here carries out datacasting to provide digital information (associated information) representing EPG information, channels of television programs, program names, or subtitles. It is to be noted that technologies related to reception and transmission of common datacasting are well known, and their detailed descriptions will be omitted.

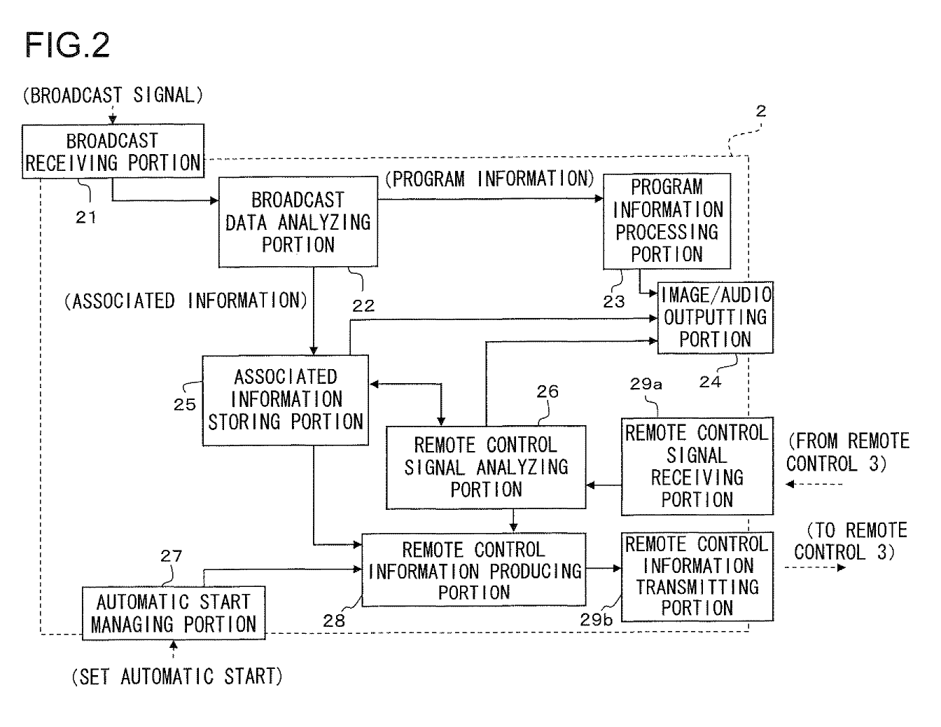

Next, the configuration of the receiving apparatus 2 will be described with reference to FIG. 2.

As shown in this figure, the receiving apparatus 2 includes a broadcast receiving portion 21, a broadcast data analyzing portion 22, a program information processing portion 23, an image/audio outputting portion 24, an associated information storing portion 25, a remote control signal analyzing portion 26, an automatic start managing portion 27, a remote control information producing portion 28, a remote control signal receiving portion 29a, a remote control information transmitting portion 29b, and so on.

The broadcast receiving portion 21 receives a broadcast signal from the television station 1, and transmits it to the following stage. For reception of a cable broadcast, a cable connecting terminal is provided; for reception of a wireless broadcast, an antenna or the like is provided. It is to be noted that the broadcast signal thus received is subjected to amplification, channel selection, and the like, where appropriate.

The broadcast data analyzing portion 22 extracts information contained in the broadcast signal, and separates the information thus extracted into program information and associated information. The program information is transmitted to the program information processing portion 23, and the associated information is transmitted to the associated information storing portion 25.

Based on the inputted program information, the program information processing portion 23 produces image/audio data for displaying and outputting images and audio of a television program, and transmits the data thus produced to the image/audio outputting portion 24. The image/audio outputting portion 24 has a display (for example, an LCD) and a loudspeaker, and displays images and outputs audio based on the image/audio data. It is to be noted that the image/audio outputting portion 24 is also used for displaying associated information, which will be described later.

The associated information storing portion 25 has a predetermined storage device, and stores the inputted associated information therein. In order to store newly-inputted associated information first, outdated associated information may be deleted when the amount of stored information exceeds a given level.

The remote control signal analyzing portion 26 analyzes the contents of a signal wirelessly transmitted from the remote control 3, and performs various kinds of processing according to the analysis results. The details of the processing will be described later.

The automatic start managing portion 27 has, for example, a device for storing automatic start information (such as preset program time and channel) and a timer for providing the current time, and has automatic start capability. More specifically, the automatic start managing portion 27 allows the user to previously set automatic start information, and automatically starts the display of images of the program of the preset channel at the preset program time. In addition, as will be described later, the automatic start managing portion 27 includes the capability of notifying the user via the remote control 3 that the preset program time has come.

Based on the associated information stored in the associated information storing portion 25, the remote control information producing portion 28 produces information (remote control information) to be transmitted to the remote control 3. In addition, when the automatic start managing portion 27 detects that the preset program time has come, the remote control information producing portion 28 produces the remote control information indicating that the preset program time has come.

The remote control signal receiving portion 29a receives a signal transmitted wirelessly from the remote control 3 (transmitting portion 39b), and transmits the signal thus received to the following stage. In addition, the remote control information transmitting portion 29b wirelessly transmits the information transmitted from the previous stage to the remote control 3 (receiving portion 39a). It is to be noted that radio waves are used as transmission media for such wireless communication. More specifically, as a wireless communication scheme that allows the receiving apparatus 2 and the remote control 3 to wirelessly communicate with each other, any one of the IEEE802.11 wireless LAN, Zigbee, and Bluetooth is adopted.

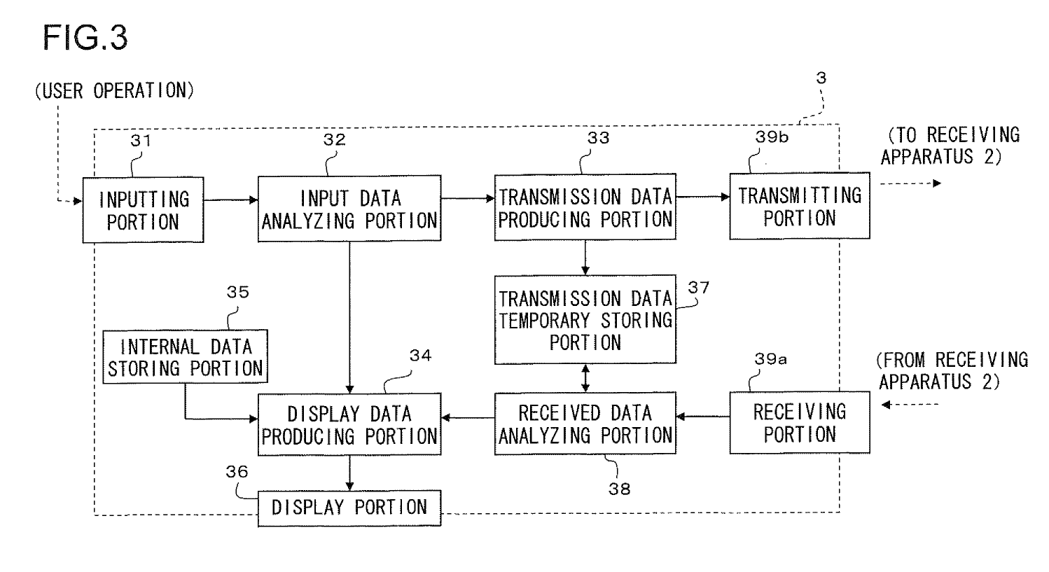

Next, the configuration of the remote control 3 will be described with reference to FIG. 3.

As shown in this figure, the remote control 3 includes an inputting portion 31, an input data analyzing portion 32, a transmission data producing portion 33, a display data producing portion 34, an internal data storing portion 35, a display portion 36, a transmission data temporary storing portion 37, a received data analyzing portion 38, a receiving portion 39a, a transmitting portion 39b, and so on.

The inputting portion 31 has a user interface provided with, for example, push buttons and dials, and obtains input data (corresponding to an instruction from the user) through the user's button operation or the like. Some examples of the instruction are an instruction (hereinafter, where appropriate, an “internal data display instruction”) to make the display portion 36 display the internal data (for example, time data from a clock built into the remote control 3) of the remote control 3, an instruction (hereinafter, where appropriate, a “receiving apparatus control instruction”) to bring the state (for example, a received channel, a sound level, and a display state of the image/audio outputting portion 24) of the receiving apparatus 2 to a desired state, and an instruction (hereinafter, where appropriate, an “associated information request instruction”) to make the receiving apparatus 2 wirelessly transmit the associated information to the remote control 3.

The input data analyzing portion 32 controls the transmission data producing portion 33 or the display data producing portion 34 according to the input data obtained by the inputting portion 31. The details of the control will be described later.

The transmission data producing portion 33 produces data (transmission data) to be transmitted wirelessly to the receiving apparatus 2. In addition, the display data producing portion 34 produces data (display data) to be displayed by the display portion 36. Furthermore, the internal data storing portion 35 stores various kinds of information such as current time measured inside the remote control 3.

The display portion 36 has a display such as an LCD, and produces a display based on the display data. In addition, the display portion 36 has a loudspeaker, and produces audio based on audio data if there is the inputting of audio data.

The transmission data temporary storing portion 37 temporarily stores the transmission data produced by the transmission data producing portion 33. As will be described later, the stored contents are used for checking whether the associated information transmitted from the receiving apparatus 2 is desired information or not.

The received data analyzing portion 38 analyzes the information received from the receiving apparatus 2, and controls the operation of the display data producing portion 34 according to the analysis results. As described earlier, the receiving portion 39a and the transmitting portion 39b enable wireless communication with the receiving apparatus 2.

In the television broadcast receiving system 9 structured as described above, the program information received by the broadcast receiving portion 21 is inputted to the program information processing portion 23 via the broadcast data analyzing portion 22. Based on the program information thus inputted, images and audio of the television program can be displayed and outputted through the image/audio outputting portion 24.

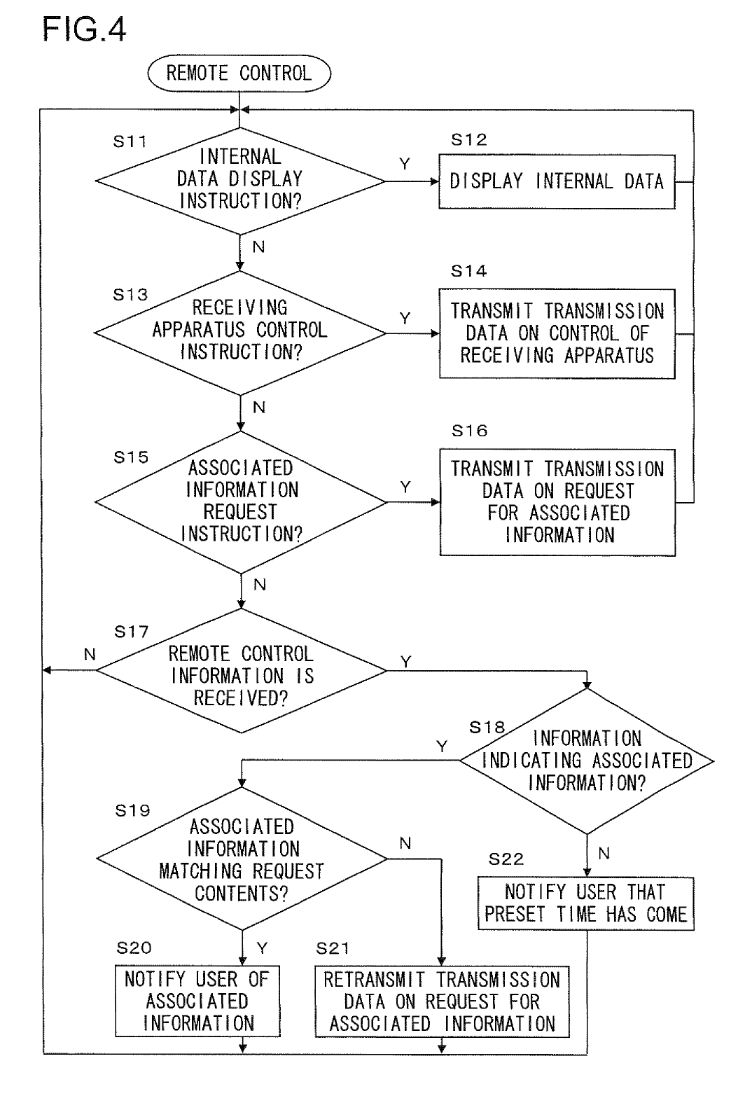

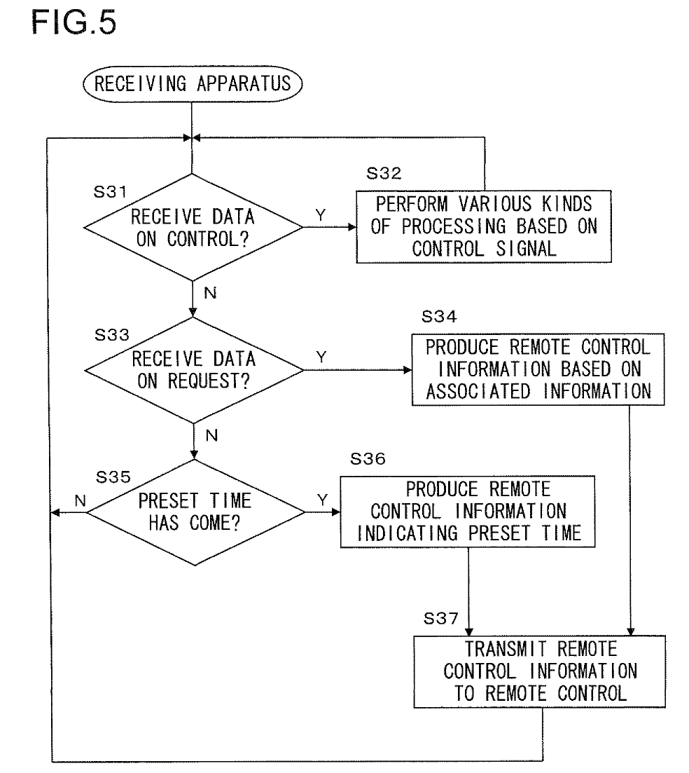

On the other hand, in the television broadcast receiving system 9, the associated information transmitted from the broadcast station 1 and then received by the receiving apparatus 2 is transferred to the remote control 3, so as to allow the remote control 3 to make use of the associated information thus transferred. In this way, this system contributes to enhancement of the convenience for users. Hereinafter, in addition to such processing, the procedures performed in the television broadcast receiving system 9 will be described with reference to the flow charts shown in FIGS. 4 and 5.

In normal times, the remote control 3 checks whether or not the aforementioned internal data display instruction, receiving apparatus control instruction, or associated information request instruction is given by the user (steps S11, S13, and S15). If the internal data display instruction is found to be given (Y in step S11), the input data analyzing portion 32 controls the display data producing portion 34 so as to make the display portion 36 display the internal data. In response to this control, the display data producing portion 34 reads the internal data from the internal data storing portion 35, and makes the display portion 36 display the internal data (step S12).

If the receiving apparatus control instruction is found to be given (Y in step S13), the input data analyzing portion 32 makes the transmission data producing portion 33 produce transmission data for controlling the state of the receiving apparatus 2. In response to this, the transmission data producing portion 33 produces appropriate transmission data, and transmits it to the transmitting portion 39b. The transmitting portion 39b wirelessly transmits the transmission data thus received to the receiving apparatus 2 (step S14).

If the associated information request instruction is found to be given (Y in step S15), the input data analyzing portion 32 makes the transmission data producing portion 33 produce transmission data for making a request of the receiving apparatus 2 to transmit the associated information. In response to this, the transmission data producing portion 33 produces appropriate transmission data, and transmits it to the transmitting portion 39b. The transmitting portion 39b wirelessly transmits the transmission data thus received to the receiving apparatus 2 (step S16). At the same time, the transmission data producing portion 33 stores, in the transmission data temporary storing portion 37, information indicating the contents of the request (for example, information indicating which type of associated information is currently requested if the receiving apparatus 2 receives two or more types of associated information).

The remote control 3 also checks whether or not the remote control information is wirelessly received from the receiving apparatus 2 (step S17). Processing performed when the remote control information is found to be received (Y in step S17) will be described later.

On the other hand, the receiving apparatus 2 checks whether or not the transmission data (the transmission data transmitted in step S14) on the control of the receiving apparatus 2 is received from the remote control 3 (step S31), whether or not the transmission data (the transmission data transmitted in step S16) on the associated information transmission request is received from the remote control 3 (step S33), and whether or not the preset program time previously set in the automatic start managing portion 27 has come (step S35).

If the transmission data on the control of the receiving apparatus 2 is found to be received (Y in step S31), the remote control signal analyzing portion 26 performs various kinds of processing based on the transmission data (step S32). If the transmission data on the associated information transmission request is found to be received (Y in step S33), the remote control signal analyzing portion 26 makes the remote control information producing portion 28 produce the remote control information based on the associated information (the remote control information indicating the contents of the associated information) (step S34).

If the preset program time is found to have come (Y in step S35), the automatic start managing portion 27 makes the remote control information producing portion 28 produce the remote control information indicating that the preset program time has come (step S36). The remote control information produced in step S34 or S36 is wirelessly transmitted to the remote control 3 via the remote control information transmitting portion 29b (step S37).

When the remote control information is transmitted in this manner, the remote control 3 detects reception of the remote control information via the receiving portion 39a (Y in step S17). If the remote control information thus received is found to be the information indicating the associated information (the information produced in step S34) (Y in step S18), the received data analyzing portion 38 checks whether the associated information thus received matches the request contents stored in the transmission data temporary storing portion 37, in other words, checks whether the associated information of a type different from that requested is erroneously received (step S19).

If the associated information thus received is found to match the request contents (Y in step S19), the received data analyzing portion 38 makes the display data producing portion 34 produce the display data based on the associated information. In response to this, the display portion 36 displays the associated information, and thereby notifies the user of the associated information (step S20). On the other hand, if the associated information thus received is found not to match the request contents (N in step S19), the transmission data requesting the transmission of the associated information is retransmitted (step S21). Incidentally, the erroneously-transmitted associated information may be deleted in parallel with the processing performed in step S21.

If the remote control information thus received is found not to be the information indicating the associated information (N in step S18), that is, if it is found to be the information produced in step S36 indicating that the preset program time has come, the received data analyzing portion 38 makes the display data producing portion produce the display data indicating that the preset program time has come. In response to this, the display portion 36 produces a display based on this display data, and thereby notifies the user that the preset program time has come (step S22).

The above-described procedures performed by the television broadcast receiving system 9 contribute to enhancement of the convenience for users. Here, to facilitate the understanding of the above-described procedures, a description will be given below of some specific examples. The following description assumes that the receiving apparatus 2 here receives at least a broadcast including EPG data.

Suppose that the user is trying to make the remote control 3 display the current time (a type of internal data). Then, an instruction to that effect is given via the inputting portion 31 (Y in step S11), and the current time is displayed on the display portion 36. In this way, the request of the user is satisfied.

Suppose that the user is trying to make the receiving apparatus 2 (the image/audio outputting portion 24) display the EPG data (a type of associated information). Then, an instruction to that effect is given via the inputting portion 31 (Y in step S13), and the transmission data for controlling the receiving apparatus 2 so as to display the EPG data is transmitted to the receiving apparatus 2 (step S14). As a result, the remote control signal analyzing portion 26 makes the image/audio outputting portion 24 display the EPG data stored in the associated information storing portion 25. In this way, the request of the user is satisfied.

Suppose that the user is trying to make the remote control 3 (the display portion 36) display the EPG data. Then, an instruction to that effect (an instruction for transferring the EPG data from the receiving apparatus 2 to the remote control 3 so as to make the remote control 3 display the data) is given via the inputting portion 31 (Y in step S15). In this way, the transmission data for requesting the transmission of the EPG data is transmitted to the receiving apparatus 2 (step S16).

As a result, the remote control signal analyzing portion 26 makes the remote control information producing portion 28 produce the remote control information indicating the EPG data stored in the associated information storing portion 25 (step S34). Then, this remote control information is transmitted to the remote control 3 (step S37). The remote control 3 checks to make sure that the remote control information thus transmitted is the EPG data (step S19), and then displays the EPG data on the display portion 36 (step S20). In this way, the request of the user is satisfied.

When the preset program time previously set by the user in the receiving apparatus 2 has come, the corresponding remote control information is transmitted to the remote control 3, and the display portion 36 indicates that the preset program time has come. This enables the user to be notified by the remote control 3 that the preset program time has come, making it possible to minimize the possibility that the preset program time has come without being noticed.

Incidentally, the image/audio outputting portion 24 and the display portion 36 may produce a predetermined sound instead of or in addition to displaying the associated information to notify the user of the associated information. Similarly, the display portion 36 may produce a predetermined sound instead of or in addition to display a given indication to notify the user that the preset program time has come.

For example, it is possible to previously store audio information in the receiving apparatus 2 and the remote control 3, and make them to produce a sound at the time to produce a display of the associated information or to provide notification that the preset program time has come. Doing so helps attract the attention of the user at an appropriate time more reliably. In addition, if the associated information itself is audio data, by producing a sound based on the associated information instead of producing a display of the associated information in the manner as described above, it is possible to provide the user with the contents of the associated information accurately.

As mentioned earlier, as a wireless communication scheme that allows the receiving apparatus 2 and the remote control 3 to wirelessly communicate with each other, any one of the IEEE802.11 wireless LAN, Zigbee, and Bluetooth, all of which use radio waves (electromagnetic waves of frequencies of 3 THz or below) as transmission media. As a result, as compared with when a communication scheme using infrared rays having high directivity (having the property of traveling in straight lines) is adopted, it is possible to transmit the information with stability. This feature is of great importance, especially because the user uses the remote control 3 by directly picking it up by hand (and this causes a change in position and orientation of the remote control).

Furthermore, with the television broadcast receiving apparatus 9, two users are allowed to communicate with each other by using the receiving apparatus 2 and the remote control 3 as transceivers. More particularly, the receiving apparatus 2 and the remote control 3 are each provided with a transmitter portion that wirelessly transmits, to the receiving side, audio information or image information according to an input of the user, and a receiver portion that performs an audio output or an image display based on the audio information or image information that is wirelessly transmitted from the transmitting side.

This enables two users, of which one is performing input to the receiving apparatus 2 and the other is performing input to the remote control 3, to perceive the audio output or image display, and thereby to communicate with each other. Also in this case, by using radio waves as transmission media for wireless communication between the receiving apparatus 2 and the remote control 3, it is possible to transmit the information more stably than when infrared-ray communication is adopted.

This is the end of the description of the embodiment of the invention. The invention may be practiced in any other manner than specifically described above, with any modification or variation made within the spirit of the invention.

According to the television broadcast receiving system of the invention, the remote control information produced in the receiving apparatus is wirelessly transmitted to the remote control by using radio waves having lower directivity (the property of traveling in straight lines) than infrared rays. This enables the receiving apparatus to wirelessly transmit the associated information and the like obtained from the broadcast station to the remote control with relative ease, making it easy to enhance the convenience for users.

What is claimed is:

1. A television broadcast receiving system, comprising:
a receiving apparatus receiving a broadcast of a television station that carries out datacasting as well as broadcasting and displaying an image of a television program; and
a remote control remotely controlling the receiving apparatus by using wireless communication,
wherein the receiving apparatus comprises:
a remote control information producing portion producing remote control information based on predetermined information, the remote control information to be wirelessly transmitted to the remote control; and
a wireless transmitting portion wirelessly transmitting the remote control information to the remote control,
wherein the remote control comprises:
a wireless receiving portion wirelessly receiving the remote control information,
wherein radio waves are used as media for wireless communication from the wireless transmitting portion to the wireless receiving portion.

2. The television broadcast receiving system of claim 1,
wherein the remote control information producing portion produces information indicating contents of the datacasting as the remote control information,
wherein the remote control comprises a first notifying portion performing a first notification process for notifying a user of the contents of the datacasting based on the remote control information.

3. The television broadcast receiving system of claim 2,
wherein the first notifying portion comprises a display device producing a display of the contents of the datacasting based on the remote control information,
wherein the first notifying portion performs the first notification process by making the display device produce the display.

4. The television broadcast receiving system of claim 3,
wherein the receiving apparatus comprises a second notifying portion performing a second notification process for notifying the user of the contents of the datacasting,
wherein the second notifying portion performs the second notification process when receiving an instruction given from the remote control to the receiving apparatus via wireless communication.

5. The television broadcast receiving system of claim 4,
wherein the second notifying portion comprises a display device producing a display of the contents of the datacasting,
wherein the second notifying portion performs the second notification process by making the display device produce the display.

6. The television broadcast receiving system of claim 1,
wherein, as a wireless communication scheme from the wireless transmitting portion to the wireless receiving portion, any one of an IEEE802.11 wireless LAN, Zigbee, and Bluetooth is adopted.

7. The television broadcast receiving system of claim 4,
wherein, as a wireless communication scheme from the remote control to the receiving apparatus, any one of an IEEE802.11 wireless LAN, Zigbee, and Bluetooth is adopted.

8. The television broadcast receiving system of claim 2,
wherein the first notifying portion produces a predetermined sound at a time of execution of the first notification process.

9. The television broadcast receiving system of claim 4,
wherein the second notifying portion produces a predetermined sound at a time of execution of the second notification process.

10. The television broadcast receiving system of claim 3,
wherein the receiving apparatus receives EPG data by the datacasting,
wherein the first notifying portion displays the EPG data.

11. The television broadcast receiving system of claim 3,
wherein the receiving apparatus receives, by the datacasting, digital data indicating at least one of a broadcast channel, a program name, and subtitles of the television program,
wherein the first notifying portion displays the digital data.

12. The television broadcast receiving system of claim 1,
wherein the receiving apparatus comprises an automatic start managing portion in which a preset program time is previously set, the automatic start managing portion starting an image display of a television program of a predetermined channel when the preset program time has come,
wherein the remote control information producing portion produces, as the remote control information, information indicating that the preset program time has come,
wherein, based on the remote control information, the remote control notifies the user that the preset program time has come.

13. The television broadcast receiving system of claim 1,
wherein the receiving apparatus and the remote control each comprise:
a transmitter portion wirelessly transmitting audio information or image information according to an input of the user to a receiving side; and
a receiver portion performing an audio output or image display based on the audio information or image information wirelessly transmitted from a transmitting side,
wherein the user performing the input to the receiving apparatus and the user performing the input to the remote control are allowed to communicate with each other by perceiving the audio output or image display.
